(19) United States
(12) Patent Application Publication
(10) Pub. No.: US 2004/0248549 A1
(43) Pub. Date: Dec. 9, 2004

(54) Entropy collection

(76) Inventor: Paul C. Drews, Gaston, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/455,270

(22) Filed: Jun. 4, 2003

(51) Int. Cl. H04B 7/185

(52) U.S. Cl. 455/410; 455/456.1; 455/12.1; 455/427

(57) ABSTRACT

A system produces an entropy stream from streams that include both random and predictable data. The predictable or error-free data is extracted and a comparator provides an error stream or entropy stream from the raw stream and the corrected stream.

Today's portable communication products have a variety of needs for random numbers, both in the area of security and broadband signaling techniques. A well-known technique for supplying the random numbers is to use a pseudo-random number generator. Pseudo-random number generators may operate by using an iterated function to generate a series of numbers that exhibit no obvious correlation from one to another, are uniformly distributed within a range and run a long time before repeating. In order to avoid starting from the same set of initial conditions, software pseudo-random number generators may allow the initial conditions to be supplied externally, that is, the random number generator is initialized from a “seed”.

In many situations it is important that the seed is a high-quality, truly random number to avoid accidental duplication or provide secrecy. Several approaches to obtaining a high-quality random number are well known. For example, a software approach may use the content or timing of user input to obtain randomness. A hardware approach may use a thermal-driven electrical noise in a circuit to obtain randomness. These approaches have disadvantages. The user-input approach is slow and requires user intervention. The hardware approach requires the addition of hardware that is not already present in the device. Moreover, hardware random number generation inherently involves unstable hardware of doubtful reliability.

As a result, there is a need for a way to obtain true random numbers by accumulating entropy from varying unpredictable aspects of the environment that are sensed by reliable components already present in a typical device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a wireless communications device having features for generating a statistically balanced random data stream in accordance with the present invention;

FIG. 2 is a diagram that illustrates one embodiment for generating the statistically balanced random data stream in accordance with the present invention;

FIG. 3 is a diagram that illustrates another embodiment for generating the statistically balanced random data stream in accordance with the present invention; and

FIG. 4 is a diagram that illustrates an algorithm for merging entropy streams from multiple sources to produce an aggregate entropy stream at a higher rate.

It will be appreciated that for simplicity and clarity of illustration, elements illustrated in the figures have not necessarily been drawn to scale. For example, the dimensions of some of the elements are exaggerated relative to other elements for clarity.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Embodiments of the present invention may be used in a variety of applications, with the claimed subject matter incorporated into microcontrollers, general-purpose microprocessors, Digital Signal Processors (DSPs), Reduced Instruction-Set Computing (RISC), Complex Instruction-Set Computing (CISC), among other electronic components. In particular, the present invention may be used in smart phones, communicators and Personal Digital Assistants (PDAs), medical or biotech equipment, automotive safety and protective equipment, and automotive infotainment products. However, it should be understood that the scope of the present invention is not limited to these examples.

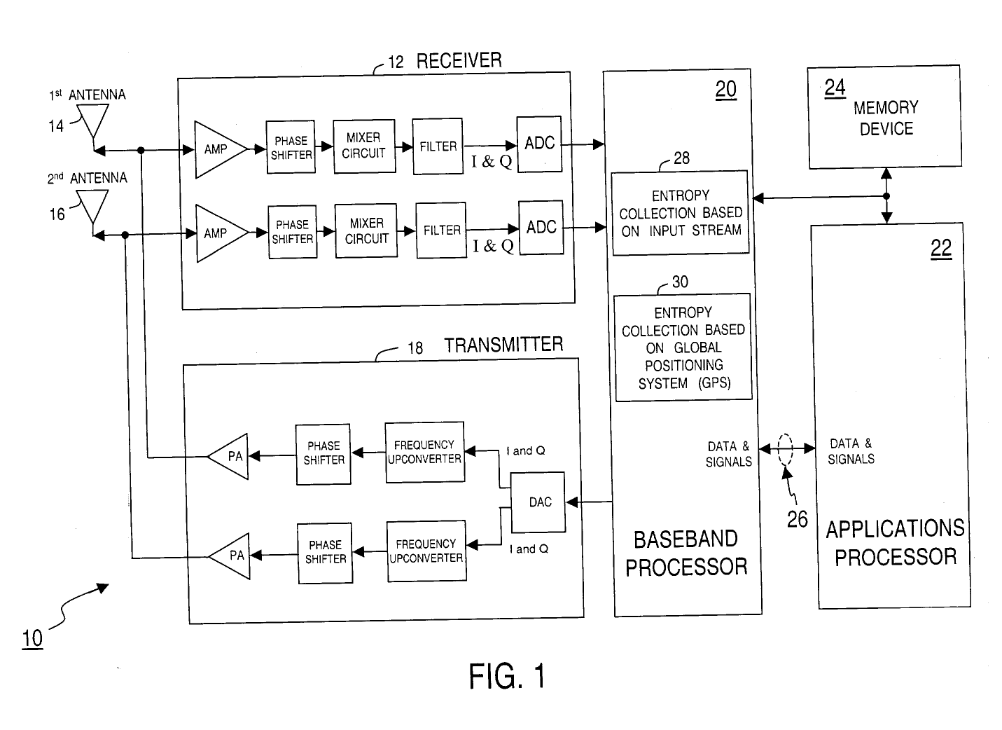

FIG. 1 illustrates features of the present invention that may be used to generate a statistically balanced random data stream that may be incorporated into a wireless communications device 10. In this device the transceiver receives and transmits modulated signals from antennas 14 and 16, although a single antenna or multiple antennas are not a limitation of the present invention. The first and second receiver chains may each include amplifiers such as, for example, Low Noise Amplifiers (LNAs) and Variable Gain Amplifiers (VGAs) to amplify signals received from the multiple antennas. Mixer circuits receive the modulated signals in the first and second receiver chains and down-convert the carrier frequency of the modulated signals. The down-converted signals may then be filtered and converted to a digital representation by Analog-To-Digital Converters (ADCs).

A baseband processor 20 may be connected to the ADCs to provide, in general, the digital processing of the received data within communications device 10. Baseband processor 20 may process the digitized quadrature signals, i.e., the in-phase “I” signal and the quadrature “Q” signal from the first and second receiver chains. In order for wireless communications device 10 to transmit data, transmitter 18 may receive digital data processed by baseband processor 20 and convert the digital data to analog signals for transmission from multiple antennas 14 and 16. Note that receiver 12 and/or transmitter 18 may be embedded with baseband processor 20 as a mixed-mode integrated circuit, or alternatively, the transceiver may be a stand-alone Radio Frequency (RF) integrated circuit.

An applications processor 22 may be connected to baseband processor 20 through a signaling interface 26 that allows data to be transferred between baseband processor 20 and applications processor 22. A memory device 24 may be connected to baseband processor 20 and applications processor 22 to store data and/or instructions. In some embodiments, memory device 24 may be a volatile memory such as, for example, a Static Random Access Memory (SRAM), a Dynamic Random Access Memory (DRAM) or a Synchronous Dynamic Random Access Memory (SDRAM), although the scope of the claimed subject matter is not limited in this respect. In alternate embodiments, the memory devices may be nonvolatile memories such as, for example, an Electrically Programmable Read-Only Memory (EPROM), an Electrically Erasable and Programmable Read Only Memory (EEPROM), a flash memory (NAND or NOR type, including multiple bits per cell), a Ferroelectric Random Access Memory (FRAM), a Polymer Ferroelectric Random Access Memory (PFRAM), a Magnetic Random Access Memory (MRAM), an Ovonics Unified Memory (OUM), a disk memory such as, for example, an electromechanical hard disk, an optical disk, a magnetic disk, or any other device capable of storing instructions and/or data. However, it should be understood that the scope of the present invention is not limited to these examples.

As shown in the figure, an entropy collection circuit 28 may gather entropy based on an input stream and an entropy collection circuit 30 may gather entropy based on Global Positioning System (GPS). Although the circuitry is shown as part of the baseband processor 20, it should be pointed out the task of entropy collection may span both baseband processor 20 and applications processor 22.

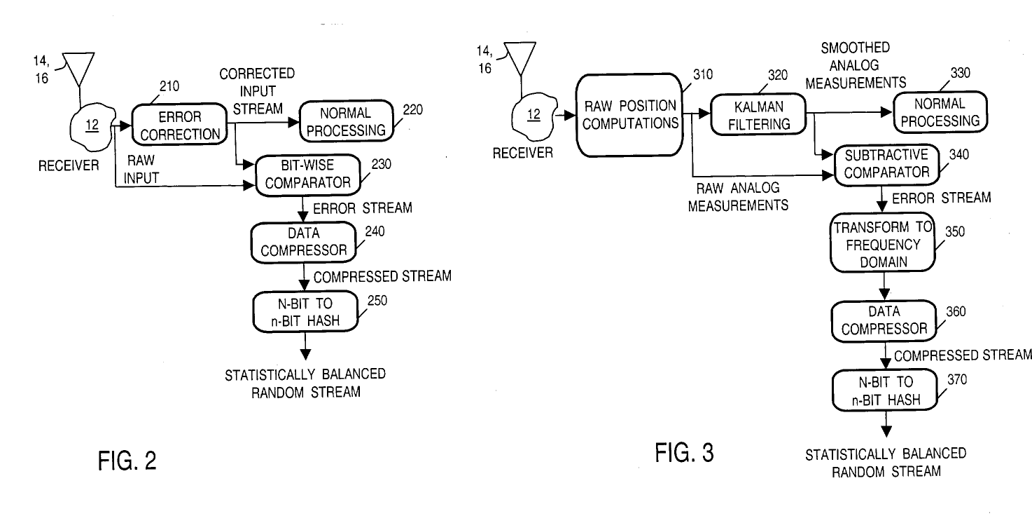

FIG. 2 is a diagram that illustrates entropy collection using a cellular input stream. With the input stream provided by receiver 12 to baseband processor 20, the principles of the present invention may be practiced in wireless communications device 10. Modern wireless and cellular communication protocols may use spread-spectrum techniques to spread a digital signal over a discrete set of frequencies or even a continuous frequency band. As such, wireless communications device 10 may be connected in a Code Division Multiple Access (CDMA) cellular network and distributed within an area for providing cell coverage for wireless communication device 10. Additionally, the principles of the present invention may be practiced in Wireless Local Area Network (WLAN), Wide Area Network (WAN), Personal Area Network (PAN) and Local Area Network (LAN), among others.

Well-known techniques may be used to recover the corrected digital information stream from the raw input digital information stream received in one of the receiver chains connected to either of antennas 14 and 16 (Process 210). The technique for data correction may include either software or special-purpose hardware, or a combination thereof. Once corrected, the error corrected digital information stream may be passed to baseband processor 20 and/or applications processor 22 for normal processing (Process 220). However, in contrast to other communication devices that pass only the corrected digital information stream along the signal-processing chain, the present invention includes features that compare the corrected digital information stream with the raw uncorrected stream to produce an error stream (Process 230).

The digital information error stream contains randomness, however, it may not be purely random. For instance, noise sources may affect the digital information stream and have periodic behavior over time. Such noise sources may arise from other transmissions in the same frequencies, the environment, misalignment between the transmitter and receiver clocks and the transmitter and receiver circuitry. In accordance with the present invention, a processing step is inserted into the error digital information stream to predict the stream as well as possible, and remove the prediction, leaving a stream that's as random as possible.

In this embodiment for predicting and removing periodic behavior, a compression algorithm is used to recognize repeating strings of various lengths. These repeating strings are encoded as shorter indexes into a catalog of known strings (Process 240). In the present invention the compression algorithm may include techniques to shuffle the most common strings to catalog positions with short indexes. Strings that appear rarely may be discarded from the catalog, allowing shorter indexes to be used to keep the compression ratio high. Further, the output may be statistically balanced between logic ones and logic zeros by running the output through a suitable hash function (Process 250).

This compression algorithm differs from other compression algorithms in that the catalog definitions are not included in the output stream. Since rarely used strings become discarded from the catalog, the catalog acts as a “sliding window” that characterizes the recent behavior of the input stream. It should be noted that the size of this sliding window may be tuned for different kinds of input streams. For a good compression algorithm, the output bit rate is a measure of the rate of accumulation of entropy, which is useful in determining the “quality” of a random seed generated from the stream. The same processing steps are readily applicable to any digital input stream that includes errors that can be eventually distinguished from data, where the errors obey a degree of random behavior.

FIG. 3 is a diagram that illustrates entropy collection using Global Positioning System (GPS) error. This embodiment applies to positioning systems in general. Some specific examples of positioning systems include the Global Positioning System (GPS) and/or cell-phone locating systems based on analysis of signals exchanged between cell phones and transceivers. In such positioning systems there is some unpredictable error in the computed position since any error that is readily predictable ahead of time is detected and “subtracted out” in any well-designed system. Such systems are generally digital in most parts of their design and the error is a digital measure of an analog quantity, i.e., the position of the device. A stream of position measurements or their errors provides a set of digitized samples of an analog signal for a channel (Process 310). Although only one channel is described, the present invention is applicable for use in multiple channels, e.g., x, y, z, and time.

Positioning systems receive raw position measurements and may use some variation of sliding-window averages, Kalman filters or other techniques to get corrected position measurements (Process 320). The corrected position measurements are passed along for further processing by the device (Process 330). In accordance with the present invention, the uncorrected position measurement stream is compared with the smoothed analog measurement stream to produce an error stream (Process 340).

In this embodiment for compressing the digitized analog signals, the error stream is transformed from the time domain into the frequency domain (Process 350). This may be accomplished using Fourier transforms or other transforms based on correlating the error stream against suitably chosen waveforms represented at a series of time-scales. The resulting frequency-domain signal tends to be readily compressible using a data compressor based on repeating strings of varying length (Process 360). Applying the transform to successive “windows” of input samples inherently provides a sliding window that allows the compression to adapt to signal behavior that changes gradually over time. Some tuning of the particular transform and the size of the window may accommodate input streams from different kinds of positioning devices or different channels from the same device. Those skilled in the art will recognize that transforms other than frequency-domain transforms may be used. The present invention may use any transform that exposes the predictable nature of the error stream so that a subsequent compressor may achieve a higher compression ratio. As with the previous embodiment, a hash function may be used to statistically balance the output stream (Process 370).

As shown, a general-purpose architecture produces “pure” entropy streams from streams that include both random and predictable data. The architecture includes extracting the predictable or error-free data, then using a comparator to provide an error stream from the raw stream and the smoothed analog measurements or corrected digital stream. An optional domain-specific predictor may transform the error stream into strings with a high degree of repetition and a data compressor may be modified to reduce repetition to its pure entropy bit rate. An optional hash computation step may balance logic ones and logic zeros and reduce the output bit rate by a further ratio.

The use of a time-domain to frequency-domain transformation as a “predictor” before the data-compression stage achieves a better compression ratio. Although it may not be possible to distinguish the “error” from the true position, this embodiment distinguishes predictable position measurements from unpredictable ones to more accurately characterize the true entropy of the signal. The actual changes in position contribute to the entropy collected by the invention insofar as they are unpredictable.

In the embodiments illustrated in FIGS. 2 and 3, the compression technique with the best compression ratio may be selected to allow the output bit rate to be used as an accurate measurement of the rate of entropy collection. However, there may be cases in which a poorer compression algorithm would be desirable for performance or other reasons. If there is a way to determine the ratio between the poorer compression algorithm and an ideal compression algorithm, the output of the poorer compression algorithm may be converted to the “corrected” output rate by means of the hash function simply by choosing a sequence of input bits for each hash that is longer than the output hash by a suitable ratio.

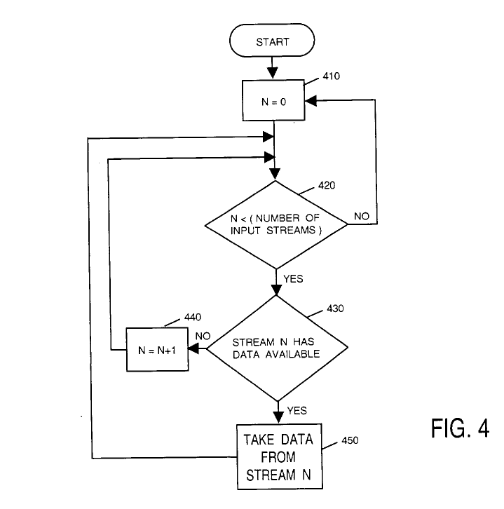

FIG. 4 is a diagram that illustrates an algorithm for merging entropy streams from multiple sources to produce an aggregate entropy stream at a higher rate. An integer variable N is set initially to zero (Process 410) and checked against the number of input streams (Process 420). If the input stream has data available (Process 430), then data is taken from the stream (Process 450). However, if the input stream does not have data available then the variable N is incremented (Process 440) and data is taken from another stream (Process 450). By way of example, entropy from a cellular input stream and entropy from position measurements may be combined into an aggregate entropy stream. Those skilled in the art will recognize that a wide variety of algorithms may be used to combine entropy streams. The present invention is not restricted to a particular way of combining entropy streams.

By now it should be appreciated that several embodiments have been provided that overcome some of the disadvantages of collecting entropy from environmental sensors or sensors that need operator intervention. In the present invention the disadvantage that it takes time to collect sufficient entropy is still present, however, by combining as many entropy sources as possible the collection rates of each source can be added together to form a higher rate.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method, comprising:
capturing entropy from a bit stream having recoverable errors.

2. The method of claim 1 wherein capturing entropy from a bit stream further includes capturing entropy from a wireless input stream.

3. The method of claim 1 wherein capturing entropy from a bit stream further includes capturing entropy from positioning measurements.

4. The method of claim 3 capturing entropy from positioning measurements further includes taking position measurements from a Global Positioning System (GPS).

5. The method of claim 1 further comprising:
reducing an input stream containing repetition to a bit stream of its inherent entropy rate.

6. The method of claim 5 further comprising:
compressing the error stream to produce a stream at the error stream's inherent entropy rate.

7. The method of claim 6 further comprising:
compressing repeating strings of varying length to generate the error stream.

8. The method of claim 7 further comprising:
replacing repeating strings of varying length with shorter unique strings.

9. A method, comprising:
using a stream of digital samples of an analog signal that has some predictable and some unpredictable behavior to generate entropy.

10. The method of claim 9 wherein using the stream of digital samples includes receiving measurements based on a positioning system.

11. The method of claim 9 further including comparing the stream of digital samples of the analog signal with a corrected analog stream to provide an error stream.

12. The method of claim 11 further including compressing the error stream to generate an entropy stream.

13. The method of claim 12 further including hashing the compressed stream to statistically balance the entropy stream.

14. A method, comprising:
generating first entropy from a first source and second entropy from a second source and combining the first and second entropy.

15. The method of claim 14 further including generating first entropy from a cellular input stream and second entropy from measurements based on a positioning system.

16. The method of claim 14 wherein combining the first and second entropy further include deriving entropy from the first source when data is available and deriving entropy from the second source when data from the first source is not available.

17. The method of claim 14 wherein generating first entropy from a first source further includes comparing an analog stream with a corrected analog stream to provide an error stream.

18. A system that generates entropy, comprising:
a baseband processor coupled to at least one antenna to receive a modulated signal;
a Static Random Access Memory (SRAM) memory coupled to the baseband processor; and
an entropy collection system coupled to receive raw input signals from the modulated signal and generate corrected input signals that are compared with the raw input signals to provide an error stream.

19. The system of claim 18, further including:
a data compressor to receive the error stream and provide a compressed stream.

20. The system of claim 19, further including:
a hash circuit to receive the compressed stream and provide a statistically balanced stream.
